(19) United States
(12) Patent Application Publication
(10) Pub. No.: US 2014/0074493 A1
(43) Pub. Date: Mar. 13, 2014

(54) MEDICAL PROTECTION LOCKOUT SYSTEM FOR PROCEDURES AND DEVICES

(71) Applicants: DAVID LYLE SCHNEIDER, NEW YORK, NY (US); J. KEITH DEWYNGAERT, FAIR HAVEN, NJ (US); MARTIN A. ATWOOD, CANON CITY, CO (US)

(72) Inventors: DAVID LYLE SCHNEIDER, NEW YORK, NY (US); J. KEITH DEWYNGAERT, FAIR HAVEN, NJ (US); MARTIN A. ATWOOD, CANON CITY, CO (US)

(21) Appl. No.: 13/731,214

(22) Filed: Dec. 31, 2012

Related U.S. Application Data
(60) Provisional application No. 61/631,326, filed on Jan. 3, 2012.

(51) Int. Cl. G06F 21/32; G06Q 50/22

(52) U.S. Cl. CPC G06F 21/32; G06Q 50/22
USPC 705/2; 340/5.82

(57) ABSTRACT

A medical protection safety lockout system for procedures and devices which can be integrated internally or retrofitted externally to any electronic medical equipment providing treatment or diagnostic medical care to a patient. Methods include both Patient acceptance process, verifying patient acknowledgement and medical procedure consent, and Clinician acceptance process, acknowledging patient identity and appropriate clinical procedure sign-offs. The apparatus and methods deliver reliable and trustworthy patient safeguards to electronic medical equipment.

### CROSS-REFERENCE TO RELATED APPLICATIONS

See provisional of same 61/631,326, Jan. 3, 2012.

### STATEMENT REGARDING FEDERALLY SPONSORED RESEARCH OF DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF INVENTION

This invention applies to the field of electronic medical devices and improving patient safety. Background discussion follows which focuses on general industry practice with regard to electronic medical devices, in practical daily usage, and general mistake risks in the medical provider industry.

### DEFINITION OF COMMON TERMS

Patient Safety—

Patient safety is a professional discipline emphasizing reporting, analyzing, and preventing medical mistakes that can cause injury.

Identifiers—

Identifiers are unique items that can positively identify one specific patient and only that specific patient. For example, common medical industry identifiers are photo identification, full name, medical record number, date of birth and a barcode wristband. Less common identifiers within the medical industry are biometric items such as fingerprints, palm prints, retina scans etc.

Positive Patient Identification—

mandatory standards for confirming the patient identity prior to delivering medical care or treatment delivery. British National Health Service (NHS) documentation describes the common medical industry process like this: “Patients know better than anyone who they are so they must confirm their identity wherever this is possible. It is acknowledged that this is not always the case (e.g. where there is cognitive impairment) and must always be considered.”

Patient Safety Processes—

refers to policies and procedures used by medical professionals to reduce and prevent medical mistakes. There are universal standards promoted by trade associations, regulators and international groups such as World Health Organization (United Nations).

Electronic Medical Record (EMR); Electronic Health Record (EHR)—

the universal trend in the medical industry for retiring paper documents and processes, in favor of electronic systems. These phrases describe a patient's medical information which is electronic rather than paper form. There are significant changes with workflow, people and systems when using an electronic medical record or electronic health record compared with historic paper documentation.

Medical Equipment Use Procedures—

refers to policies and procedures specific to electronic medical equipment and the medical departments and technicians using the equipment.

Medical Equipment or Electronic Medical Equipment—

refers generically to any medical devices, apparatus, machine or unit that provides a medical treatment to a patient, or a diagnostic medical study or test to a patient.

Medical Equipment Clinician or Medical Equipment Operator—

refers generically to trained staff who are designated to safely and effectively control or operate any medical equipment for purpose of treating or diagnosing human patients. Another common term is medical technician or generically “tech.”

Clinician—

refers generically to trained and professional persons including physicians, nurses and medical technicians with more limited training. All provide service to the patient.

### BACKGROUND DISCUSSION

Patient safety initiatives and quality improvements have been, and continue to be, critical industry-wide goals, both in the United States and internationally. Medical centers and professionals in the United States are popularly considered to be industry pioneers and innovators for medical devices, medical care delivery, and medical safety standards and oversight. Delivering quality patient care and insuring patient safety are the primary, critical job role for medical professionals and medical administrators.

There is a significant, meaningful impact and public benefit with continued innovation in products and devices which help protect patient safety and deliver quality patient care.

Consider the scope and impact from medical mistakes, quickly summarized here from a small selection of published articles, and one can see the continued need for innovating in this field:

“Medication errors can compound a medical crisis, sometimes with tragic results. On average, a U.S. hospital patient is subjected to at least one medication error per day, and medication errors contribute to more than 7,000 inpatient deaths per year in the United States.” [1] [published material in Robert Wood Johnson Foundation healthcare article, citation below]

“One third of x-ray and radiological incidents occur when examinations are carried out on the wrong patient. According to the Health Care Commission, ionizing radiation can cause harm and increase the risk of cancer in extreme cases. Although the majority of incidents reported to the watchdog involved low doses, a total of 80 incidents involved CT scanning, in which the radiation doses are high and could pose a risk.” [2] [published in NetDoctor.co.uk healthcare article, citation below]

The current standard practice in medical industry usage basically involves using double-identifiers, which means checking the patient's identity with two or more unique identifiers. For example, the current methods to identify the correct patient prior to a medical procedure in the United States normally include two identifiers originating with the patient registration during sign-in, including photo identification (i.e. government identification) and date of birth (DOB) which is then matched to the patient's unique hospital serial number, commonly called a medical record number (MRN). When a medical procedure commences, the clinicians will typically verbally confirm two or more identifiers in order to check for “the correct patient.” In recent years, hospitals and clinics have moved over to electronic methods for positive patient identification, most notably “barcode technology” such as bar code wristbands or labels for both patients and their medications. These labels are checked by medical professionals before the administration of a drug or medical procedure. This is a reasonable process considering that patients are subject to multiple procedures, medicines and movements within a fast-paced and high-volume medical facility.

With regard to radiology procedures and radiation therapy treatments, in general usage, patients are typically identified as they enter the treatment room by the clinical technician. This identification is often done with a photograph and a verbal confirmation of patient's date of birth, for example. A recent industry development is that patient wristbands including barcodes are becoming standard in outpatient facilities. For many years, the industry has widely required barcode wristbands inside hospital inpatient facilities.

One caveat with barcode technology is that, even with barcode labels physically present, the barcode remains a single identifier which can be mistaken. The potential risk with delivering the correct procedure and the correct identification remains with the clinical technician (i.e. one individual) to confirm the correct patient and procedure: this is a manual process since double-identifiers are not validated electronically in current industry practice. To emphasize current and future trends, the medical industry is strongly standardizing upon universal barcode scanning and correlating the patient within various electronic medical record and electronic scheduling systems, including wristband safety and financial billing systems. The barcode provides the key identifier which is effectively a barcoded MRN number correlating to a unique patient.

Despite these positive trends, preventing mistakes and incorrect identification can be challenging in settings where different languages are spoken, where patient names are similar, where volumes are high, and where fast-paced and high-stress environments result in staff members working with patients they do not routinely see or personally know.

Regarding the trend toward barcode and biometric identifiers within the medical industry, the following author describes five priority areas needing improvement:

“Some common goals of patient identification systems should include: Raise patient safety standard levels; Reduce hospital liability; Verify the identity of unconscious patients; Lower language barriers; And prevent medical identity theft.” [3] [published in Advanceweb.com healthcare article, citation below]

We note that current medical industry standards do not barcode the clinical technician who provides the treatment delivery with medical equipment: most electronic medical equipment today identifies staff with system usernames and related access passwords for operating medical equipment (i.e. common medical equipment consoles today are Microsoft Windows and other embedded operating systems controlling the medical equipment).

Recapping, the medical industry standard, more specifically within the United States, is for electronic medical record (EMR) systems which use barcode methods to positively identify patients and medications. Barcode methods also record medications and procedures stored within EMR audit and billing records. The current field has widely deployed Electronic Medical Record systems and this is becoming the standard of practice in the United States. In practical terms, this means that a barcoded MRN serial number exists as the key patient identifier.

The impact related to patient safety is that risks remain for incorrect patient identification and medical equipment operation by unauthorized or unqualified staff. This challenge affects both medical industry providers and, most importantly, patients who risk misadministration of care. In short, these risks can result in serious injury, due to relatively simple mistakes.

### CITED SOURCES

[1] Robert Wood Johnson Foundation. Internet published article “Better Environments for Nurses Mean Fewer Medication Errors,” 2012 Aug. 28.
[2] NetDoctor.co.uk. Internet published article “Third of x-ray mistakes involve wrong patient,” Adfero Ltd, 2008 Mar. 14.
[3] Advanceweb.com healthcare trade magazine, “Biometrics offers many benefits in preventing duplicate medical records,” Michael Trader, 2012 Aug. 17.

### BRIEF SUMMARY OF THE INVENTION

A medical protection lockout system for procedures and devices which can be integrated internally or retrofitted externally to any electronic medical equipment that provides treatment or diagnostic medical care to a patient. Both medical patient and medical equipment operator are positively identified and consent to authorized medical treatment or diagnostic service, including both radiological and other medical equipment. This system operates a unique operating combination with 3 core modules delivering highly reliable and trustworthy patient safeguards on modern medical equipment.

### BRIEF DESCRIPTION OF THE SEVERAL VIEWS OF THE DRAWING

FIG. 1: Depicts the apparatus including its 3 component modules with physical connections to outside industry equipment. The circle encases the core apparatus components (hardware and software) which function in combination to deliver safety interlock. The dotted lines show electronic connections interfacing to any commercially-available medical equipment vendor.

FIG. 2: Example showing the electronic connectivity with different types and vendors of biometric reader devices, such as fingerprint readers, ID smartcard readers, face-scan readers or other types of biometric readers.

FIG. 3: Example showing the interface of the Interlock Module and the electronic connectivity with outside electronic medical equipment of various types and vendors. The dotted lines indicate both the physical electrical connection and the data flows specified by the outside electronic medical equipment.

### DETAILED DESCRIPTION OF THE INVENTION

This invention is comprised of an electronic medical apparatus and its three (3) component methods, composed with hardware, software and electronic cabling circuits in entirety. The invention combines, at a minimum, the three inherent components resulting in the apparatus demonstrated in the embodiment examples. The essential design necessitates, at a minimum, all three (3) components combined and interdependent . . . comprising the invention.

Here are term definitions for the core components comprising this invention:

Core Safety Module—

This in computer terms is the physical, tangible hardware which includes the three (3) component methods and the necessary electronic circuitry for connecting to outside electronic medical equipment and other outside systems as needed by the specific electronic equipment manufacturer and product. The Core Safety Module also provides control software with registration, management and reporting capabilities through standard interfaces, and optional connections to flat or touch display.

Patient Accept Module—

This in computer terms is described best as software. This functions internally within the Core Safety Module and also communicates externally with outside hardware and outside information. The Patient Accept Module software provides communications with any commercially-available outside biometric reader hardware (specific biometric reader products are out-of-scope of invention). Method of this component is to validate and positively confirm that the patient matches the expected patient scheduled on the medical equipment, in addition to patient acceptance of the medical equipment appointment.

Clinician Accept Module—

This in computer terms is described best as software. This functions internally within the Core Safety Module and also communicates externally with outside information. Method of this component is to validate and positively confirm the clinician (specifically a “medical equipment operator”) authorization, as described in more detail in the example embodiments.

Interlock Module—

This in computer terms is a combination of hardware or software which is responsible for communicating a common lock or unlock signal to the outside electronic medical equipment. In common implementation this is a simple “state circuit” which communicates electrically a lock or unlock state (electrically an On or Off circuit). While actual implementation will vary to match each individual vendor and product, in the industry this is a common concept called an interlock or lockout circuit. Lockout mechanisms have been used for over a hundred years and are effectively a common and open technology, with various implementations including proprietary manufacturer implementations. The Interlock Module described in this invention uses the technology or system compatible with each specific electronic medical equipment manufacturer, or more precisely, the interlock specification originates with the electronic medical equipment itself. Specific interlock technology products are out-of-scope of this invention.

Materials

The materials used for assembling the invention are generally called embedded hardware and an embedded operating system. As a current example, sellers of these materials include vendors such as Texas Instruments, Intel, Motorola, various ARM hardware manufacturers including foreign manufacturers. A current example of software materials would be Wind River, Green Hills Software, Linux, BSD, Solaris or Microsoft Windows Embedded 7/8 software. The invention itself does not depend upon any specific vendor or technology and will therefore be implemented with the best-available technology over time. A likely implementation will be reducing the invention to practice with materials such as a single-board or single-chip proprietary application-specific integrated circuit . . . a common practice in the electronics and microcontroller industry. There are at least two practical implementations for the invention:
1. In one embodiment, the invention can be included internally inside existing electronic medical equipment with connections that mate directly to the electronic medical equipment—this we describe as an integrated, internal implementation.
2. In another embodiment, the invention can be included external to electronic medical equipment with industry-standard data connectivity products, such as electrical cable, Ethernet connection, fiber-optical connection or wireless connection. This we describe as a retrofitted or external implementation.

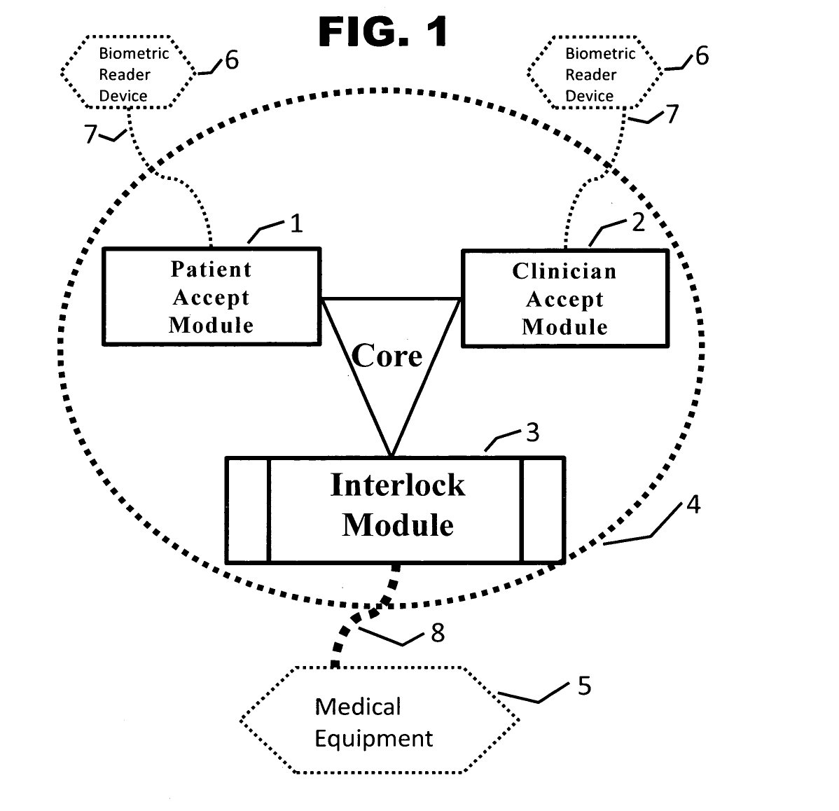

Detail of FIG. 1:

This comprises the apparatus and its three (3) essential, combined methods which are physically composed of hardware, software and electronic connectivity. In practical terms, the invention delivers physically on one single circuit board with external connections to any unrelated outside equipment (outside equipment we describe as out-of-scope and not included in boundaries of the invention).

The callouts describe the following components and connections: 1) Patient Accept module, a method and software component with primary function to positively identify and validate the one-to-one match of the correct patient designated for the medical procedure or treatment; 2) Clinician Accept module, a method and software component with primary task to positively identify the clinician, or clinicians responsible for operating the medical equipment and delivering medical services; 3) Interlock module, a method implemented functionally with hardware and software which is responsible for communicating with the medical equipment itself; 4) Core Safety Module, a generic phrase we use to describe the combined components and methods which make up the invention claimed and in scope (shown here within the drawn circle for clarity); 5) Medical equipment, any third-party medical equipment including electronic medical equipment, equipment which medically treats patients, and equipment which provides medical diagnostic service to patient; 6) Any biometric reader device, this describes commercially-available biometric readers such as fingerprint readers, ID smartcard readers, face-recognition readers, etc. etc., which can be connected and compatible with the Core Safety Module (4) as shown with dotted-line connection (7). Additionally, the medical equipment itself is connected physically through electrical circuits or data cabling which may include industry standard serial or low-voltage wiring, as shown in dotted-line connection (8).

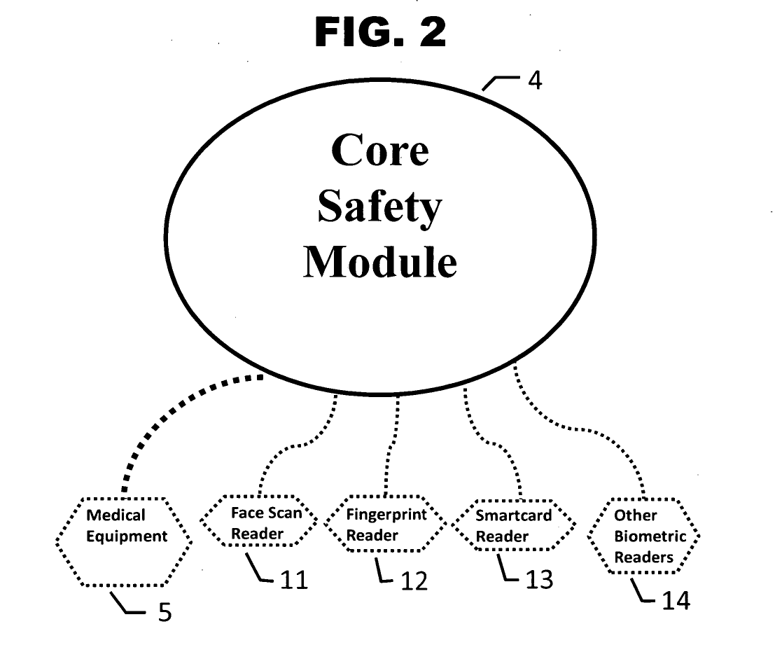

Detail of FIG. 2:

This shows examples of how the Core Safety Module (4) connects, or interfaces, to a commercially-available biometric reader device (6), at a minimum one, and how the Core Safety Module (4) can connect and interface to any commercially-available biometric reader technology, through data connections that are physical or wireless (7). In practical terms, these connections (7) are done through any industry standard such as serial, USB, Firewire or wireless standards such as Bluetooth or Intel wireless standards. As vendors change and improve products, the specific connections will change over time.

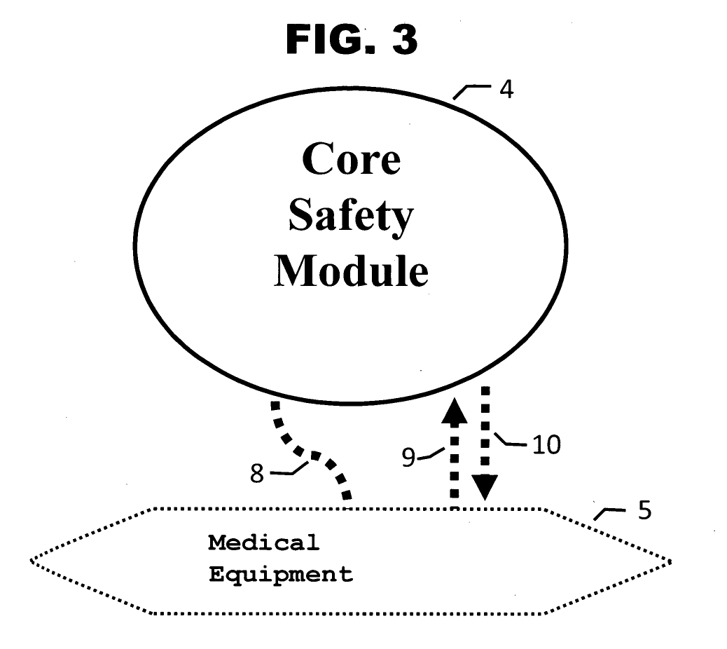

Detail of FIG. 3:

This figure shows how the Core Safety Module (4) connects to any commercially-available electronic medical equipment (5). Examples of electronic medical equipment include medical treatment equipment, medical diagnostic equipment, radiation therapy equipment, radiology imaging equipment, or various other medical treatment electronic delivery devices. The physical connectivity from the Core Safety Module (4) to the outside medical equipment (5) is designated with the dotted lines (8). The logical or data flow connectivity is a two-way communication shown in (9) and (10). Outgoing interlock and patient information, varies with specific implementation, delivers down with dotted-line connection (10). Incoming patient and procedure information originating from medical equipment delivers up through dotted-line connection (9). Software programming (11) integrates the three components and requires the positive Core Safety Module approvals, which are computer logic “AND” condition gates, mandated before an open interlock is delivered to outside medical equipment.

These are the two high-level information flows between the invention and the medical equipment: Firstly, the outgoing information is the “interlock” provided to the medical equipment (10); Secondly, the incoming information (9) is the patient information including basic patient demographic data, and, optionally, information specific to the electronic medical equipment itself such as medical procedure data and other clinical information. For example, in complex medical equipment, the medical equipment will provide the medical procedure or perhaps the medical prescription for the specific patient. In simpler medical equipment, the medical equipment will provide only basic patient information necessary for identification.

—End Diagram Descriptions—

### Example Implementations

An example embodiment implemented with radiological medical equipment:

To illustrate, this is a general example how invention can be utilized with medical equipment delivering radiotherapy treatment:
1. Patient arrives at medical equipment for treatment.
2. Medical equipment is prepared with patient treatment plan and specific patient prescription through the normal process dependent upon equipment vendor (i.e. mode-up or vendor-specific programming that delivers medical care).
3. Medical equipment, through its interfaces, communicates to Core Safety Module the scheduled patient identifiers—at a minimum one and preferably multiple identifiers—where the identifiers represent the current patient engaged, or intended to be engaged, on the medical equipment.
4. Clinician (i.e. qualified medical equipment operator) follows the usual, typical procedures to identify and communicate treatment directions and instructions, in the same manner typically performed.
5. Patient presses thumbprint on a thumbprint reader device, located at the point or vicinity of treatment, to accept the appointment and the medical treatment.
6. Clinician follows the usual, typical procedures to prepare patient and assess clinical care necessary on equipment.
7. Clinician presses thumbprint on a thumbprint reader device, located in vicinity of treatment room or treatment controller, to accept and sign-off on the medical treatment.
8. Core Safety Device validates and confirms positive identification of both patient and the clinician. This automatic safety double-check system therefore delivers an interlock “go” or “no-go” signal to the medical equipment interlock system (the specific implementation of interlocks and safety circuits will vary with vendor and equipment). In lay terms, a thumbprint that does not match the pre-registered thumbprint expected from the patient engaged on medical equipment results in a safety interlock . . . a hard-stop preventing medical treatment and alarming warnings requiring further clinical assessment.

An example embodiment implemented with medical infusion pump:

Another illustration, this is a general example how invention can be utilized with electronic medical infusion pumps, specifically smart pumps, delivering intravenous pharmacy treatment to patient:
1. In this example, the generic infusion smart pump and its supporting prescription system already integrate information technology into the smart pump system . . . therefore the medical equipment vendor knows the patient and the prescription assigned to the smart pump. (this is existing medical technology outside scope of this invention)
2. Smart pump is pre-loaded with patient name, birthdate, weight and other requisite settings including the specific prescription through the normal process specific to the smart pump. This may be a fully-automated preloading performed by the smart pump control system through wireless data connections, or this may be manual pre-loading procedure.
3. Smart pump system communicates to Core Safety Module the patient identifiers—at a minimum one and preferably multiple identifiers—where the identifiers represent the patient planned and expected on the smart pump.
4. Clinician (infusion nurse or qualified clinician) follows usual and typical procedures to clean, prepare and check the smart pump equipment.
5. Patient arrives at point of care.
6. Clinician matches and connects patient to the smart pump equipment, most likely through an inert intravenous (IV) feeder line that does not contain any active medicinal products.
7. In coordination with pharmacy, clinician prepares and connects prescription IV bags with the correct mounting order and location mandated by the smart pump. These prescription bags contain pharmacy products delivering medical treatment to patient. (we point out that a multichannel pump can deliver more than one drug simultaneously, with different flow rates)
8. Clinician communicates with patient, through the usual and typical procedure, the instructions, prescription and treatment details, in same manner typically performed.
9. Patient presses thumbprint on an integrated thumbprint reader device located on the treatment pump, in order to confirm and accept the medical treatment.
10. Clinician follows the usual, typical procedures to prepare patient and assess clinical care considerations.
11. Clinician presses thumbprint on an integrated thumbprint reader device located on the smart pump, in order to sign-off with correct smart pump configuration and patient setup.
12. Core Safety Device validates and confirms positive identification of both patient and the clinician. This delivers a “go” or “no-go” signal to the smart pump system, providing an additional safety check before the smart pump will activate. In lay terms, a thumbprint that does not match the pre-registered thumbprint expected from the patient engaged causes a safety interlock preventing equipment operation and treatment.

### Other Embodiments

Considering the wide range of medical equipment currently on the market, there are many possible variations where this invention can be included, integrated or externally attached to electronic medical equipment providing enhanced safety benefits to medical equipment manufacturers and, most importantly, to the patients who trust this medical equipment for medical care.

What is claimed is:

1. The invention comprised of a medical apparatus and method that enforces a timeout and medical safety lock based upon the function of, in combination and in plurality, the positive identification acceptance of patient and the positive identification acceptance of medical equipment clinician, or clinicians, through a technical means included internally or externally into any common electronic medical equipment; and where in operation the medical apparatus requires a plurality, two or more, positive biometric identifications provided through any commercially-available thumbprint reader or readers (any brand or vendor), in one embodiment, or alternatively through any commercially-available biometric reader or readers (any brand or vendor), in alternate embodiments.

2. A method including said apparatus in claim 1, where the said medical apparatus internally handles these biometric identifiers, in plurality, in a proprietary and confidential manner which we call a “proprietary security token,” and such security token guarantees the specific, one-to-one, positive identification of patient and clinician or clinicians, in plurality.

3. A method including said apparatus in claim 1, where the said medical apparatus requires positive patient identification available from any commercially-available biometric reader (any brand or vendor), and specifically this positive patient identification embodies and certifies patient consent and acceptance within the medical apparatus.

4. A method including said apparatus in claim 1, where the said medical apparatus requires positive clinical treatment provider identification, available from any commercially-available biometric reader (any brand or vendor), and this positive clinical treatment provider embodies and certifies clinical verification that the procedure matches the patient within the medical apparatus.

5. An apparatus and method including said apparatus in claim 1, where the medical safety apparatus is included internally within any commercially-available medical treatment equipment, in various embodiments, including integration with radiological equipment of various types and technologies, including those delivering treatment with radiation therapy, electron, proton or radio-frequency (RF), and including those which deliver exposure with radiological imaging equipment such as diagnostic imaging, MRI, PET-CT, X-Ray, sonic, radio frequency (RF) or infrared equipment, and including those which deliver pharmacy products such as infusion pumps, smart pumps, anesthesia equipment and related equipment, with consideration that the commercially-available clinical treatment equipment itself is outside the scope of this invention.

6. An apparatus and method including said apparatus in claim 1, where the apparatus and method is physically designed into a single board (i.e. circuit board or printed circuit board) or single chip (i.e. in industry terminology application-specific integrated circuit, ASIC)

7. An apparatus and method including said apparatus in claim 1, where the medical safety apparatus is included internally in any medical software controlling or advising electronic medical equipment (i.e. a software-only implementation of the invention).

8. An apparatus and method including said apparatus in claim 1, where the medical safety apparatus includes additional audit logging software communicating to the outside electronic medical equipment and systems, and this module reports the patient and the clinician identifications done at time of medical equipment operation, via industry-standard data communication such as HL7 or XML interfaces to any outside information systems, and this audit reporting can be used for medical billing activity and medical fraud prevention.
